(19) United States
(12) Patent Application Publication
(10) Pub. No.: US 2026/0049888 A1
(43) Pub. Date: Feb. 19, 2026

(54) Apparatus for Detecting Blind Leaks in a Fire Suppression System

(71) Applicant: Siemens Industry, Inc., Alpharetta, GA (US)

(72) Inventor: Christopher Paolinetti, Mundelein, IL (US)

(73) Assignee: Siemens Industry, Inc., Alpharetta, GA (US)

(21) Appl. No.: 18/807,464

(22) Filed: Aug. 16, 2024

(51) Int. Cl. G01M 3/38; A62C 37/50

(52) U.S. Cl. CPC G01M 3/38; A62C 37/50

(57) ABSTRACT

Apparatus and methods detect blind leaks in a fire suppression system. A valve assembly comprises an absorption spectrometer and a controller, in which the absorption spectrometer include a light source and a light sensor. A first generated light is emitted from the light source. A first measured light corresponding to the first generated light is detected at the light sensor at a first receiving time. A second generated light is emitted from the light source. A second measured light corresponding to the second generated light is detected at the light sensor at a second receiving time different from the first receiving time. A concentration of an extinguishing agent between the light source and the light sensor is determined based on a difference between a first measurement of the first measured light and a second measurement of the second measured light.

### TECHNICAL FIELD

This application relates to the field of fire suppression cylinders and, more particularly, to devices for detecting blind leaks in fire suppression cylinders.

### BACKGROUND

Fire suppression cylinders are containers that store a chemical or inert gas that may be discharged to extinguish a fire hazard. Leaks by a fire suppression cylinder are detected by means of a refrigerant sniffer. This class of tool is primarily designed to detect leaks in refrigerant lines, such as those found in air conditioners and refrigerators. In this use case, the surrounding volume of air is large and free to circulate; and the sensor probe can be placed close to the leak (usually in direct contact with spot in the line where the leak is occurring).

When these conditions are satisfied, two critical assumptions are valid: (1) the amount of gas measured at the sensor is directly proportional to the leak rate at that location; and (2) any contamination in the surrounding air is quickly diluted to such a low concentration that even a tiny leak stands out above the ambient reading. Accordingly, the sniffer outputs data as a leak rate (mass per unit time). However, these assumptions are invalid when a non-negligible volume of air lies between a leak source and the test point (such as the valve assembly of a fire suppression cylinder). This introduces several sources of error into the measurement.

For safety in the event of an accidental discharge during handling, the outlet port of a pressurized cylinder must be equipped with an anti-recoil plug immediately after it is filled. This plug serves to direct any discharge through four orthogonal orifices such that no net thrust is produced; it must remain in place until the cylinder is either emptied or connected to appropriate plumbing. By necessity, it severely limits airflow into and out of the valve assembly.

At room temperature, the fire suppression fluid, dodecafluoro-2-methylpentan-3-one (commonly known as FK-5-1-12) is a liquid with a large vapor pressure of 5.85 pounds per square inch; and readily evaporates to a gas which is about eleven times denser than air. At normal atmospheric pressure, its saturation concentration in air is almost 40% by volume. For reference, the vapor pressure of water under the same conditions is 0.46 pounds per square inch-meaning that at 100% relative humidity, the air is 3% water by volume.

Allowable leak rates for fire suppression cylinders can be as low as 0.35 US ounces per year (0.02 milligrams per minute). When there is a non-negligible volume of air between the leak and the test point (as is created by the geometry of a valve assembly and the presence of an anti-recoil plug), it can take a considerable amount of time for leaking FK-5-1-12 to “fill” the valve assembly's volume and establish a sufficient diffusion gradient such that it begins spilling out through the anti-recoil plug in an amount detectible by a refrigerant sniffer. As a result, a small leak in a valve may go unnoticed during manufacture and end-of-line inspection.

At the sensitivity setting necessary to detect leaks this slow, the refrigerant sniffer's signal-to-noise ratio is already at its poorest; and the physical realities of the application create additional confounding variables. Pressurized cylinders often do not have separate fill and outlet ports, so the valve assembly is essentially guaranteed to be contaminated with FK-5-1-12 during the fill process. Forced-air ventilation of the assembly (e.g.: with compressed air) can be helpful but may not eliminate all contamination. As a result, if FK-5-1-12 is detected at the anti-recoil plug, it is impossible to know for sure whether the sniffer is signaling a leak in the valve or merely detecting contamination that, due to the airflow bottleneck created by the anti-recoil plug, is prevented from diffusing away.

Leaks may appear, resolve, or change in magnitude over time. Some cylinders are equipped with a low-pressure switch for the detection of pressure loss; but generally, they do not activate until the system is significantly below its rated pressure. They are useful for verifying a successful discharge or indicating that a cylinder has suffered catastrophic damage; not for detecting small leaks. It would therefore be beneficial to have the ability to monitor a very small leak over time-both as a process control on the production line and also as a potential feature to integrate into fire suppression systems, allowing both for remote leak detection, and also allowing known leaks within the acceptable range to be monitored.

### SUMMARY

In accordance with one embodiment of the disclosure, there is provided an ultraviolet (UV) light approach for detecting blind leaks in fire suppression cylinders. Detection and quantification of internal leaks in pressurized fire suppression systems.

One aspect is an apparatus for detecting blind leaks in a fire suppression system. A valve assembly comprises an absorption spectrometer and a controller, in which the absorption spectrometer includes a light source and a light sensor. The light source emits a first generated light and emits a second generated light. The light sensor is positioned a predetermined distance from the light source. The light sensor detects a first measured light corresponding to the first generated light at a first receiving time and detects a second measured light corresponding to the second generated light at a second receiving time different from the first receiving time. The controller is coupled to the light sensor of the absorption spectrometer. The controller determines a concentration of an extinguishing agent between the light source and the light sensor based on a difference between a first measurement of the first measured light and a second measurement of the second measured light.

Another aspect is a method for detecting blind leaks in a fire suppression system. A first generated light is emitted from a light source of an absorption spectrometer of a valve assembly. A first measured light is detected at a light sensor of the absorption spectrometer at a first receiving time. The light sensor is positioned a predetermined distance from the light source, and the first measured light corresponds to the first generated light. A second generated light is emitted from the light source. A second measured light is detected at the light sensor at a second receiving time different from the first receiving time. The second measured light corresponds to the second generated light. A concentration of an extinguishing agent between the light source and the light sensor is determined based on a difference between a first measurement of the first measured light and a second measurement of the second measured light.

Yet another aspect is a non-transitory computer readable medium including executable instructions which, when executed, causes at least one processor to detect blind leaks in a fire suppression system in accordance with the above method.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is an illustration of a valve assembly attached to the top of a fire suppression cylinder in an example implementation that is operable to employ techniques described herein.

FIG. 2 is a close-up view of the side chamber of the valve assembly in which the absorption spectrometer is represented in an example implementation.

FIG. 3 is a graphical view of sensor counts of the absorption spectrometer, in an example implementation, based on extinguishing agent concentrations.

FIG. 4 a block diagram of a processor of the absorption spectrometer, in an example implementation, of FIGS. 1 and 2.

FIG. 5 is a flow diagram of an operation of the absorption spectrometer, in an example implementation, operable to employ the techniques described herein.

### DETAILED DESCRIPTION

Various technologies that pertain to systems and methods that facilitate detection of blind leaks in fire suppression cylinders system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Examples of extinguishing agents include FK-5-1-12. FK-5-1-12 absorbs ultraviolet light between 250 and 350 nanometers in wavelength, with peak absorption occurring at 305 nanometers. Ambient air is essentially transparent to much of this range. 305 nm falls in the UV-B band (280-315 nm), which is perhaps most commonly known as causing the painful effects of sunburn.

According to Beer's law, light passing through a sample of n species is attenuated according to the sum of the products of each species' absorptivity and its concentration in the sample:

$$A = log \frac{{I}_{0}}{I} = ℓ {{\sum }_{i = 1}}^{n} {ε}_{i} {c}_{i}$$

where l is the optical path length, εᵢ is the absorptivity of the i-th species, and cᵢ is the concentration of the i-th species. The absorbance A is the logarithm of the ratio between the radiant intensity of the light as it enters the sample, divided by its intensity as it leaves the sample.

By shining ultraviolet (UV) light in the 250-350 nm range through a sample of air and onto a light sensor with corresponding sensitivity, any extinguishing agent present in the sample will absorb some of the light, attenuating the intensity measured at the sensor. By comparing this attenuated signal to that measured when the sample contains air alone, the concentration of the extinguishing agent in the sample may be calculated.

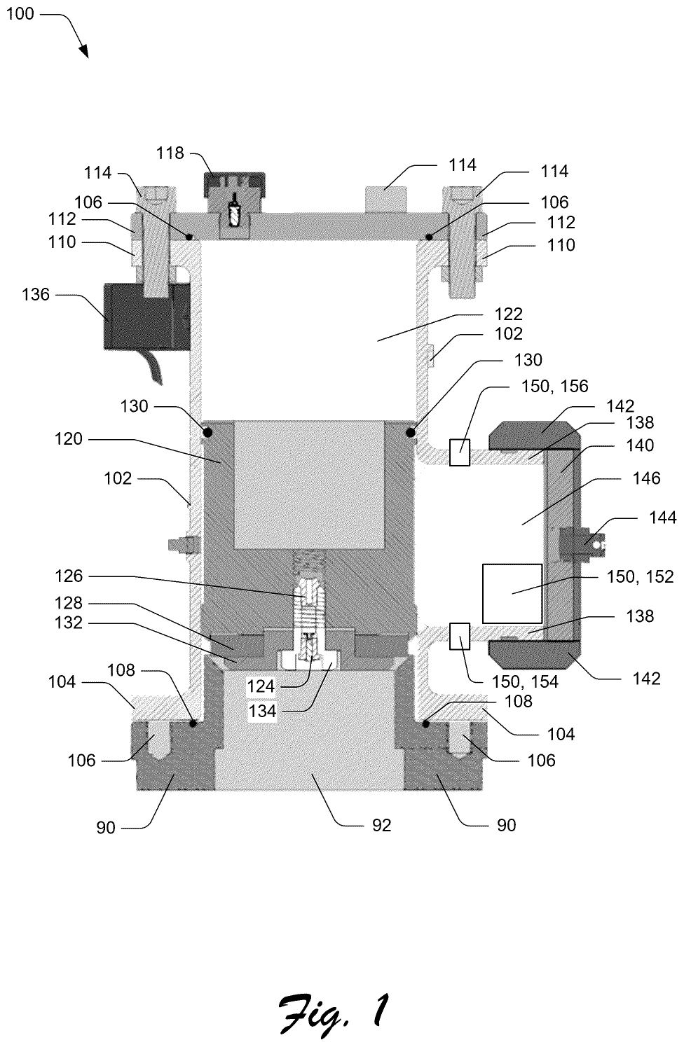

Referring to FIG. 1, there is shown a valve assembly 100 for a fire suppression cylinder in an example implementation. The fire suppression cylinder is a compact container to store a fire-suppressing agent that may be released at an open end 90 to extinguish a fire hazard or hinder it from spreading. The valve assembly 100 includes a housing 102 having a lower portion 104 that is secured to the open end 90 of the fire suppression cylinder by one or more fasteners, such as a lower fastener 106. A lower end gasket 108 provides a secure seal between the lower portion 104 and the open end 90.

The housing 102 of the valve assembly 100 includes an upper portion 110, and a top plug adapter 112 may be secured to the upper portion by one or more fasteners, such as an upper fastener 114. An upper end gasket 116 provides a secure seal between the upper portion 110 and the top plug adapter 112. The valve assembly 100 may also include a valve core 118 for certain configurations where master-slave coordination may be desired, via a pressure valve, in association with a control panel of a fire suppression system. For example, a flex hose may connect the valve assembly 100 to the discharge piping or to the manifold in multiple cylinders arrangement. The purpose of the flex hose is to connect cylinders in the master-slave configuration, where the master cylinder (with releasing solenoid) supplies pressure release to extra cylinders.

The valve assembly 100 includes a piston 120 within a body of the housing 102 between the lower and upper portions 104, 110. Under normal conditions, the piston 120 is supported within the body such that pressure within lower and upper chambers 92, 122 of the valve assembly 100 are equivalent, such as 360 lbs. per inch². The position of the piston 120 may move linearly as the pressure within one or both chambers 92, 122 changes. The piston 120 includes an excess flow assembly 124 and filter 126 to control volume flow between the chambers 92, 122 as may be needed during the operation of the valve assembly 100. The piston 120 also includes a seat 128 to provides a seal between the piston and the lower chamber 92 at the open end 90 of the fire suppression cylinder and a piston gasket 130 to provide a seal between the upper chamber 122 and the piston. A seat retainer 132 supports the seat 128 at the lower end of the piston 120, and a piston fastener 134 secures the seat retainer at the lower end of the piston. The piston fastener 134 also supports the excess flow assembly 124 and the filter 126 at the lower end of the piston 120.

The valve assembly 100 may also include pressure supervision switch 136. The pressure supervision switch 136 for certain configurations where coordination may be desired, via a pressure switch, in association with a control panel of a fire suppression system. The switch 136 remains in a normally closed position when no pressure is set against the switch and, when the cylinder valve is pressurized, the switch will move to the open position. Pressure-releasing components may be used for manual or automatic pressure actuation, which relieves the pressure above the piston 120 and permits the piston to travel upward. The pressure supervision switch 136 may be an electronic solenoid on the valve assembly 100 actuates pressure relief above the piston to permit the piston to travel upward.

The housing 102 of the valve assembly 100 includes a side portion 138 between the lower and upper portions 104, 110 and extending to one side of the body where the piston 120 resides. A flexible coupling 142 may secure temporarily a plug assembly 140 and an anti-recoil plug 144 to the side portion 138 for transport. When the assembly and cylinder are installed, the flexible coupling 142 attaches a fire suppression system plumbing (not pictured) to the side portion 138 and a side chamber 146. By doing so, the side portion 138, the flexible coupling 142, and the plumbing allow fire suppression liquid and/or gas escape from the fire suppression cylinder to fire suppression devices distributed within a designated area based on the position of the piston 120 within the body of the valve assembly. For example, if the pressure within the valve assembly 100 changes such that the piston 120 moves linearly away from the open end 90 of the fire suppression cylinder, the fire suppression liquid and/or gas may transition through the side chamber 146 of the side portion 138.

The valve assembly 100 includes an absorption spectrometer 150 for leak detection and quantification, such as an internal spectrometer 152 or an integrated spectrometer 154, 156. The spectrometer 150 measures the concentration of an extinguishing agent, such as FK-5-1-12, in the valve assembly 100 over a period of time. For some embodiments, the spectrometer 152 may be positioned internally within the housing 102 of the valve assembly 100. For some embodiments, the spectrometer 154, 156 may be positioned, i.e., integrated, at one or more sections of the housing 102 of the valve assembly 100. The spectrometer 150 includes a communication means, whether wired or wireless, to communicate with one or more devices or components external to the housing 102 of the valve assembly 100.

Measurements and analysis by the absorption spectrometer 150, 152, 154 require several considerations. A true leak causes the concentration of the extinguishing agent inside the valve assembly 100, such as the upper chamber 122, side chamber 146, or other smaller areas within the assembly, to increase over time. In contrast, contamination due to a transient, assignable cause may not cause the concentration of the extinguishing agent to increase. Also, even in the event of a true leak, regulatory bodies allow a certain leak rate before requiring that a cylinder be taken out of service. In such case, an inspector may err on the side of tolerating false positives in order to ensure that a real leak is not missed. However, if a leak rate can be shown to be holding steady at an acceptable level over an extended period of time, a manufacturer or owner may have more confidence in the measurement and avoid unnecessary cylinder teardowns.

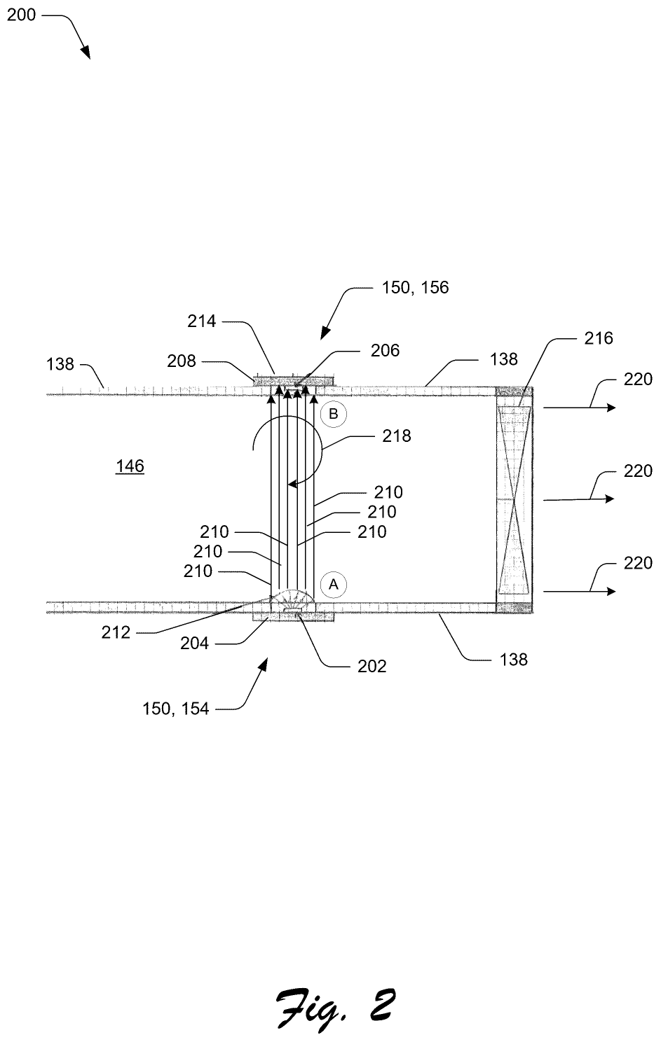

Referring to FIG. 2, there is shown an apparatus 200 representing some embodiments of the integrated spectrometer 154, 156 at one or more sections of the housing 102 of the valve assembly 100 for detecting blind leaks in a fire suppression system. The integrated spectrometer 154, 156 is integrated at one or more sections of the housing 102 of the valve assembly 100. The apparatus 200 may also be represented by other embodiments, such as the internal spectrometer 152 positioned internally within the housing 102 of the valve assembly 100, as shown in FIG. 1. For these embodiments, FIG. 2 illustrates the absorption spectrometer 150 and some of its functions in an example implementation. For example, for the embodiments, the absorption spectrometer 150, 152, 154, 156 is established within an inner portion of the valve assembly 100, such as the side chamber 146. For simplicity and ease of understanding of the spectrometer 150 and these functions, certain components of the valve assembly 100 are not shown, such as the plug assembly 140, the flexible coupling 142, and the discharge port 144 shown in FIG. 1.

For the embodiment shown in FIG. 2, the absorption spectrometer 150 includes a lower part 154 and an upper part 156. The lower part 154 includes a light source 202 supported at a lower surface of the side chamber 146 by a lower base 204 and a light sensor 206 supported at an upper surface of the side chamber by an upper base 208. Thus, the light sensor 206 is positioned a predetermined distance from the light source 202. The light source 202 emits generated light 210 at various times during the operation of the absorption spectrometer 150. For example, the light source 202 generates a first generated light at a first emission time. The light source 202 also emits a second generated light at a second emission time subsequent to the first emission time. For some embodiments, the light source 202 may include a lens 212 to guide some or all of the generated light 210 emitted by the light source. For some embodiments, the generated light 210, including the first and second generated lights, are ultraviolet lights, i.e., within the ultraviolet portion of the electromagnetic radiation spectrum.

In response to these emissions by the light source 202, the light sensor 206 detects at least some of the generated light 210 emitted by the light source 202. The light sensor 206 detects a first measured light corresponding to the first generated light at a first receiving time. The light sensor 206 also detects a second measured light corresponding to the second generated light at a second receiving time different from the first receiving time. The first measured light represents a first air sample between the light source and the light sensor having a non-presence of the extinguishing agent. For a non-presence of the extinguishing agent, the first air sample would include a minimal level of the extinguishing agent. An extinguishing agent, such as FK-5-1-12, absorbs ultraviolet light in the UV-B range, with peak absorptivity at a wavelength of about 305 nm. Air is relatively transparent to this range. The second measured light represents a second air sample between the light source and the light sensor having a presence of the extinguishing agent. The presence of the extinguishing agent, particularly beyond a leak threshold level of the extinguishing agent, would indicate a leak within the valve assembly 100 from the fire suppression cylinder. For example, by shining ultraviolet (UV) light through a sample of air and onto a light sensor 206 with corresponding sensitivity, any extinguishing agent present in the sample will absorb some of the light 210, attenuating the intensity measured at the sensor. For some embodiments, the range of UV light may be within the 250-350 nm range. By comparing this attenuated signal to that measured when the sample contains air alone, the concentration of the extinguishing agent in the sample may be calculated.

A controller 214 supported by the upper base 208 is coupled to the light sensor 206 of the absorption spectrometer 150. The controller 214 determines a concentration of an extinguishing agent between the light source 202 and the light sensor 206 based on a difference between a first measurement of the first measured light and a second measurement of the second measured light. The difference between the first measurement and the second measurement represents the concentration of the extinguishing agent in the second air sample relative to the first air sample. For some embodiments, the controller 214 causes an alarm function of the valve assembly 100 in response to determining that the difference between a difference between the first and second measurements exceeds an alarm threshold. The controller 214 may also perform other functions of the absorption spectrometer 150. For example, the controller 214 may control the sample rate, automatically switching the light source 202 on and off, and communicate the readings to a remote device for data logging and/or further analysis.

For some embodiments, the apparatus 200 may include a fan 216 to circulate air internal to the valve assembly 100 before the light sensor 206 detects the first measured light, the second measured light, or both. For example, embodiments the air may be circulated within 218 the inner portion of the valve assembly 100. For some embodiments, the air internal to the valve assembly 100 may be circulated and drawn outward 220 from the inner portion of the valve assembly 100. The fan 216 circulates the sample to prevent stratification from skewing the result. The apparatus 200 leverages the fact that the valve assembly 100 is within a confined space, resulting in limited gas transfer and limited opportunity for error from an ambient environment.

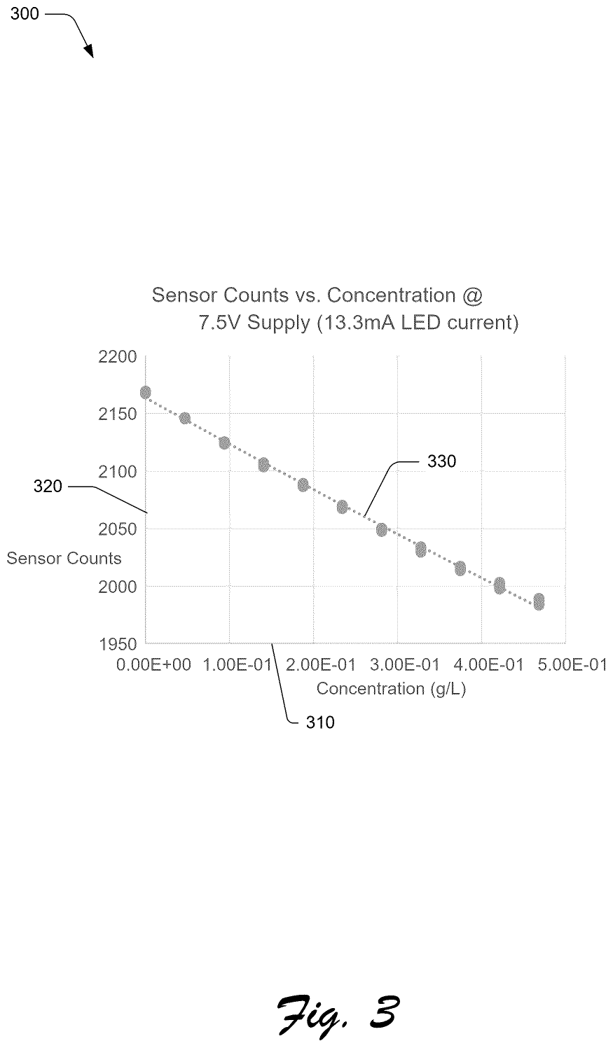

Referring to FIG. 3, there is shown a graphical view 300 of sensor counts of the absorption spectrometer 150, in an example implementation, based on extinguishing agent concentrations. The x-axis 310 of the graphical view 300 represents the concentration of an extinguishing agent in a given sample, in grams per liter (g/L). The y-axis 320 of the graphical view represents the intensity of light measured as the light sensor 206, represented by sensor counts. As the concentration of extinguishing agent in proximity to the absorption spectrometer 150 increased, the light intensity measured at the light sensor 206 decreased. For some embodiments, the relationship 330 between the concentration of the extinguishing agent in the tested sample and the intensity of the light measured at the sensor 206 may be substantially linear.

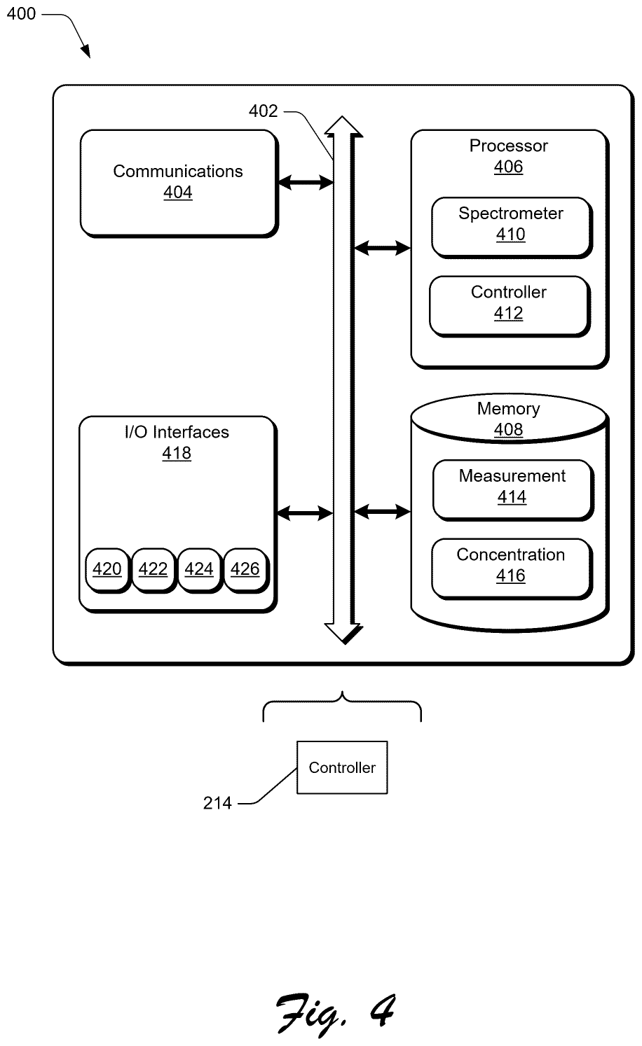

Referring to FIG. 4, there are shown controller components 400 of a controller 214 in an example implementation. The controller components 400 comprise one or more communication lines 402 for interconnecting other controller components directly or indirectly. The other controller components include one or more processors 406 and one or more memory components 408. The processor or processors 406 may send data to, and process commands received from, other components of the controller components, such as information of the memory component 408. Each application includes executable code to provide specific functionality for the processor 406 and/or remaining components of the controller 214.

Examples of applications executable by the processor 406 include, but are not limited to, a spectrometer module 410 and a controller module 412. The spectrometer module 410 controls the operations of the light source 202 and the light sensor 206, such as the emission of generated light, the detection of measured light corresponding to the generated light, and the associated timing of these emissions and detections. The controller module 412 determines the concentration of any extinguishing agent detected between the light source and the light sensor based on a difference between measurements of measured light instances.

Data stored at the memory component 408 is information that may be referenced and/or manipulated by a module of the processor 406 for performing functions of the controller 214. Examples of data associated with the controller 214 and stored by the memory component 408 may include, but are not limited to, measurement data 414 and concentration data 416. The measurement data 414 includes measurements of detected measured light instances at various receiving times. The concentration data 416 include concentrations of the extinguishing agent based on the measurement data 414.

The controller components 400 may include input/output components (I/O Interface) 418 that manages one or more input components and/or an output components of the valve assembly 1000. The input/output components 418 of the controller components 400 may also include one or more communication, signaling, visual, audio, mechanical, or other components that receive and/or provide information with an entity external to the controller 214. For example, the input/output components 418 may include a first interface 420 to send signals to the light source 202 to generate light and/or a second interface 422 to receive signals from the light sensor 206 to receive measurements corresponding to measured light. For embodiments that include multiple sources or sensors to monitor other areas or chambers of the valve assembly 200, additional interfaces 424, 426 may be included by the input/output components 418 to couple to these additional sources or sensors.

It is to be understood that FIG. 4 is provided for illustrative purposes only to represent an example implementation of the controller 214 and is not intended to be a complete diagram of the various components that may be utilized by the device. The controller 214, may include various other components not shown in FIG. 4, may include a combination of two or more components, or a division of a particular component into two or more separate components, and still be within the scope of the present invention. Also, the controller components 400 may be coupled directly or indirectly to each other to perform the operations of the controller 214.

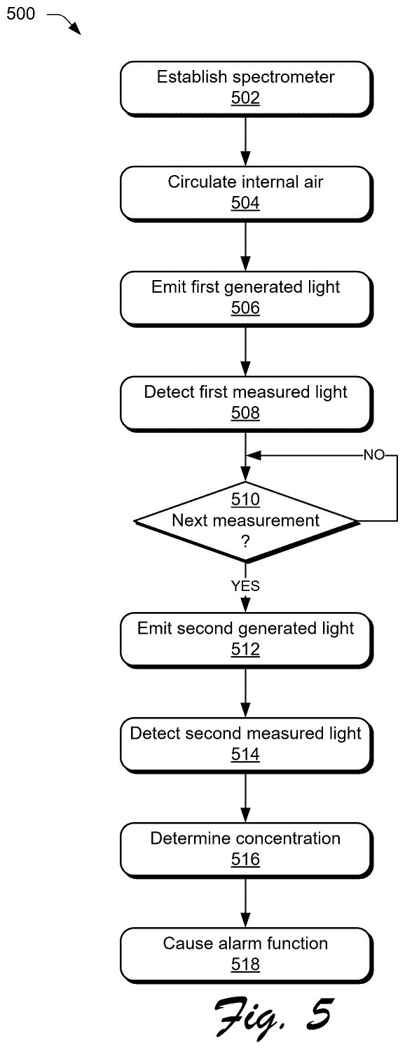

FIG. 5 is a flow diagram of an operation of the absorption spectrometer, in an example implementation, operable to employ the techniques described herein. For the method for detecting blind leaks in a fire suppression system, the absorption spectrometer 150 is established (502) within the inner portion, such as the side chamber 146, of the valve assembly 100. When establishing (502) the spectrometer 150, the light sensor 206 is positioned a predetermined distance from the light source 202. For some embodiments, air in proximity to the absorption spectrometer 150 may be circulated (504) internal to the valve assembly 100 by a valve mechanism, such as a fan 216. The air may be circulated continuously, at periodic intervals, or in response to activations. Since the circulation of the air would benefit the measurements of light 210 by the light sensor 206, the circulation may be activated or otherwise occur before detecting the first measured light, detecting the second measured light, or both measured lights.

Subsequent to establishing (502) the absorption spectrometer 150 of the valve assembly 100, the light source 202 of the spectrometer emits (506) a first generated light. For some embodiments, the first generated light is ultraviolet light. In response to the emission (506) of the first generated light, the light sensor 206 of the spectrometer 150 detects (508) a first measured light at a first receiving time. Since the light sensor 206 is detecting the light 210 emitted by the light source 202, the first measured light corresponds to the first generated light.

Subsequent to detecting (508) the first measured light, the light source 202 emits (512) a second generated light. The second generated light is the same as, or similar to, the first generated light. For example, the second generated light may be ultraviolet light. For some embodiments, the light source 202 emits (512) the second generated light in response to the light sensor 206 detecting the first measured light. For some embodiments, the light source 202 emits (512) the second generated light after determining (510) a predetermined period of time. For some embodiments, the light source 202 emits (512) the second generated light after receiving (510) an activation signal from the controller 214 or a device external to the valve assembly 100. In response to the emission (512) of the second generated light, the light sensor 206 of the spectrometer 150 detects (514) a second measured light at a second receiving time. The second receiving time is different or, more particularly, subsequent to the first receiving time. Since the light sensor 206 is detecting the light 210 emitted by the light source 202, the second measured light corresponds to the second generated light.

In response to detecting (514) the second measured light by the light sensor 206, the controller 214 determines (516) a concentration of the extinguishing agent for a sample between the light source 202 and the light sensor 206. The concentration is based on a difference between a first measurement of the first measured light and a second measurement of the second measured light. The first measured light represents a first air sample between the light source 202 and the light sensor 206 having a non-presence of the extinguishing agent. The second measured light represents a second air sample between the light source 202 and the light sensor 206 having a presence of the extinguishing agent. The difference between the first measurement and the second measurement represents the concentration of the extinguishing agent in the second air sample relative to the first air sample.

In response to determining (516) the concentration of the extinguishing agent, the controller 214 causes (518) an alarm function of the valve assembly 100. The alarm function is in response to determining that the difference between the first and second measurements exceeds an alarm threshold. For some embodiments, the controller sends an alarm signal to a device external to the valve assembly 100 via the communications component 404 or the input/output components 418. For example, the alarm signal may be communicated to a control panel of a fire suppression signal, an audio alarm device, a visual alarm device, or a remote computing device. The remote computing device may be a fire suppression management station, a remote network device, or a mobile device. For some embodiments, the controller 214 may cause a work order to be created at a computerized maintenance management system (CMMS) so that a technician may be scheduled or dispatched to service the valve assembly and/or is associated components in view of the determined concentration. For some embodiments, the controller 214 may cause a supply order to be created at a supply management system so that one or more replacement parts may be ordered and/or delivered in view of the determined concentration. For some embodiments, the controller 214 may cause a message to be sent to device associated with a fire suppression system operator, a service technician, a building maintenance person, or a building occupant in view of the determined concentration.

As a process control, the concentration measured by the assembly 200 within the valve assembly 100 eliminates valve geometry as a source of measurement error. Multiple readings taken at regular intervals, it becomes possible to distinguish between residue (in which the concentration does not increase with time) and a true leak (in which the concentration does increase with time). As a product, the assembly 200 offers the potential to detect the very beginnings of a cylinder leak, monitor it, predict its future behavior, and if necessary, proactively schedule maintenance or replacement without the need to take the affected cylinder out of service in the short term.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

1. An apparatus for detecting blind leaks in a fire suppression system comprising:
an absorption spectrometer of a valve assembly including:
a light source emitting a first generated light and emitting a second generated light; and
a light sensor positioned a predetermined distance from the light source, the light sensor detecting a first measured light corresponding to the first generated light at a first receiving time and detecting a second measured light corresponding to the second generated light at a second receiving time different from the first receiving time; and
a controller coupled to the light sensor of the absorption spectrometer, the controller determining a concentration of an extinguishing agent between the light source and the light sensor based on a difference between a first measurement of the first measured light and a second measurement of the second measured light.

2. The apparatus as described in claim 1, wherein the first and second generated lights are ultraviolet lights.

3. The apparatus as described in claim 1, wherein:
the absorption spectrometer is established within an inner portion of the valve assembly; and
the valve assembly is coupled to the fire suppression cylinder, which stores the extinguishing agent.

4. The apparatus as described in claim 1, further comprising a fan to circulate air internal to the valve assembly before the light sensor detects at least one of the first measured light or the second measured light.

5. The apparatus as described in claim 1, wherein the first measured light represents a first air sample between the light source and the light sensor having a non-presence of the extinguishing agent, and the second measured light represents a second air sample between the light source and the light sensor having a presence of the extinguishing agent.

6. The apparatus as described in claim 5, wherein the difference between the first measurement and the second measurement represents the concentration of the extinguishing agent in the second air sample relative to the first air sample.

7. The apparatus as described in claim 1, wherein the controller causes an alarm function of the valve assembly in response to determining that the difference between the first and second measurements exceeds an alarm threshold.

8. A method for detecting blind leaks in a fire suppression system, the method comprising:
emitting a first generated light from a light source of an absorption spectrometer of a valve assembly;
detecting a first measured light at a light sensor of the absorption spectrometer at a first receiving time, the light sensor being positioned a predetermined distance from the light source and the first measured light corresponding to the first generated light;
emitting a second generated light from the light source;
detecting a second measured light at the light sensor at a second receiving time different from the first receiving time, the second measured light corresponding to the second generated light; and
determining a concentration of an extinguishing agent between the light source and the light sensor based on a difference between a first measurement of the first measured light and a second measurement of the second measured light.

9. The method as described in claim 8, wherein the first and second generated lights are ultraviolet lights.

10. The method as described in claim 8, further comprising establishing the absorption spectrometer within an inner portion of the valve assembly, wherein the valve assembly is coupled to the fire suppression cylinder, which stores the extinguishing agent.

11. The method as described in claim 8, further comprising circulating air internal to the valve assembly before at least one of detecting the first measured light or detecting the second measured light.

12. The method as described in claim 8, wherein:
the first measured light represents a first air sample between the light source and the light sensor having a non-presence of the extinguishing agent; and
the second measured light represents a second air sample between the light source and the light sensor having a presence of the extinguishing agent.

13. The method as described in claim 12, wherein the difference between the first measurement and the second measurement represents the concentration of the extinguishing agent in the second air sample relative to the first air sample.

14. The method as described in claim 8, further comprising causing an alarm function of the valve assembly in response to determining that the difference between the first and second measurements exceeds an alarm threshold.

15. A non-transitory computer readable medium including executable instructions which, when executed, causes at least one processor to detect blind leaks in a fire suppression system by:
emitting a first generated light from a light source of an absorption spectrometer of a valve assembly;
detecting a first measured light at a light sensor of the absorption spectrometer at a first receiving time, the light sensor being positioned a predetermined distance from the light source and the first measured light corresponding to the first generated light;
emitting a second generated light from the light source;
detecting a second measured light at the light sensor at a second receiving time different from the first receiving time, the second measured light corresponding to the second generated light; and
determining a concentration of an extinguishing agent between the light source and the light sensor based on a difference between a first measurement of the first measured light and a second measurement of the second measured light.

16. The non-transitory computer readable medium as described in claim 15, wherein the first and second generated lights are ultraviolet lights.

17. The non-transitory computer readable medium as described in claim 15, further comprising establishing the absorption spectrometer within an inner portion of the valve assembly, wherein the valve assembly is coupled to the fire suppression cylinder, which stores the extinguishing agent.

18. The non-transitory computer readable medium as described in claim 15, further comprising circulating air internal to the valve assembly before at least one of detecting the first measured light or detecting the second measured light.

19. The non-transitory computer readable medium as described in claim 15, wherein:
the first measured light represents a first air sample between the light source and the light sensor having a non-presence of the extinguishing agent;
the second measured light represents a second air sample between the light source and the light sensor having a presence of the extinguishing agent; and
the difference between the first measurement and the second measurement represents the concentration of the extinguishing agent in the second air sample relative to the first air sample.

20. The non-transitory computer readable medium as described in claim 15, further comprising causing an alarm function of the valve assembly in response to determining that the difference between the first and second measurements exceeds an alarm threshold.
